(19) United States
(12) Patent Application Publication
(10) Pub. No.: US 2026/0060412 A1
(43) Pub. Date: Mar. 5, 2026

(54) EPOXY RESIN PIPELINING ASSEMBLY

(71) Applicant: U.S. PIPE LINING SERVICES, INC., Tampa, FL (US)

(72) Inventor: Bradley Kalis, Tampa, FL (US)

(21) Appl. No.: 19/310,273

(22) Filed: Aug. 26, 2025

Related U.S. Application Data
(60) Provisional application No. 63/687,566, filed on Aug. 27, 2024.

(51) Int. Cl. A46B 13/04; A46B 5/00; A46B 13/00; F16L 58/10

(52) U.S. Cl. CPC A46B 13/04; A46B 5/0012; A46B 13/001; F16L 58/1009; A46B 2200/20

(57) ABSTRACT

A portable pipelining assembly featuring a dual pump system and a brush system for simultaneous delivery and application of multiple liquids is disclosed. Each pump system includes a motor-driven pump connected to a dedicated reservoir for storing distinct liquids, with fluid conveyed through individual hoses and output valves. The brush system, attached to a delivery end of both hoses, comprises a motorized handle base with dual conduits that channel each liquid to rotating brushes. The brushes, powered by a secondary motor, enable concurrent dispensing and mechanical treatment of surfaces using two separate fluids, enhancing pipelining efficiency. The distinct liquids can be an epoxy resin base and an epoxy catalyst, that when mixed together form an epoxy resin used for lining cast iron pipes.

### CROSS-REFERENCE TO RELATED APPLICATION

The present application claims priority from U.S. Provisional Ser. No. 63/687,566, filed Aug. 27, 2024, which is incorporated herein by reference in its entirety.

### TECHNICAL FIELD AND BACKGROUND

This disclosure relates generally to an assembly for lining pipes with various liquid chemicals, and, more particularly, an epoxy pipelining assembly that is adapted for lining cast iron pipes with epoxy resin.

Pipes used for indoor and outdoor plumbing applications erode over time and with continuous use. Pipe sidewalls become thinner due to this erosion, and the pipe will eventually break and leak under the pressures of fluid flow. For example, problems with erosion often arise with cast iron pipes used in residential and commercial building construction. Cast iron is a strong and durable material and is found in many plumbing systems of homes and other buildings constructed before the 1970s. Over time, however, the interior of cast iron pipes is subject to wear and corrosion that leaves the pipes thin and cracked. Cast iron pipes have a life expectancy of about 40-60 years. The consequence is that many homes built with original cast iron piping systems may be starting to show signs of such corrosion.

To counter the effects of erosion, the interior of existing pipes can be lined with materials to increase the sidewall thickness and enhance structural strength. The lining can be in the form of a sheath or tube of material deposited on the interior of the pipe, or the lining can be applied in a fluid form that hardens over time to create a new layer of material in the pipe interior. Such cast iron pipe relining can offer remarkable strength and durability, providing a long-lasting solution for damaged pipes.

Conventional methods of cast iron pipe relining are often extremely wasteful, costly, and inefficient. Fluid lining material used in the relining process is typically a specially formulated epoxy resin made from a base and a catalyst for its polymerization or curing. When the two-component epoxy is applied to a pipe interior in fluid form, the fluid cures and hardens into a rock-like substance. Once cured, the pipe liner becomes strong and capable of withstanding the rigors of everyday use.

Conventional systems mix the epoxy resin base and catalyst prior to applying the mixture to a surface. Upon mixing the base and catalyst, the working time or countdown to cure begins, as the resin begins to immediately harden upon activation. Once the epoxy hardens on the interior of the hose used to dispense the epoxy, the hose and the excess epoxy resin itself must be thrown away as waste because of the inability to apply the mixture within the working time window. Furthermore, conventional methods require multiple applications (e.g., 6-8 applications) that amplify the amount of waste. The result is that about one third of the total epoxy resin is unusable waste. For conventional systems that mix the epoxy resin base and catalyst prior to a pump unit, the cured material becomes deposited within the pump over time and results in degradation of pump performance.

Other methods of epoxy resin application include spraying the epoxy resin base and epoxy catalyst onto the cast iron pipes to mix the epoxy resin base and epoxy catalyst when sprayed. The material is deposited to the interior of a pipe using a tube or hose. Sprayers are often hand actuated and leave intermittent rings on the interior of a pipe as an operator pushes and withdraws the sprayer through the pipe. Sprayers utilize a hybrid polyuria compound with a viscosity low enough to facilitate spraying the coating over a wider surface area and through small nozzles. However, materials that have a viscosity low enough for spraying do not have the tensile strength of epoxy compounds.

The spray head applicator uses an air compressor to facilitate spraying and mixing. Typically, the spray head applicator must be thrown away after each application as the epoxy hardens. Additionally, air compressors with sufficient power to deposit epoxy are often large and heavy. The large size is a significant disadvantage because pipe lining is commonly performed in small spaces where plumbing is installed, and the heavy weight limits the ability to physically and economically transport the apparatus. Moreover, air compressors produce heat and increase the ambient temperature, including the temperature of the epoxy resin. When epoxy resin is warmed, it cures faster. This warming can produce challenges as it may negatively affect the working time and conditions for pipe relining.

Traditional methods of relining cast iron pipes are expensive, wasteful, and require the use of heavy, non-portable machinery. It is, therefore, an object of the present disclosure to provide an epoxy resin pipelining assembly that is lightweight, portable, and reduces the waste associated with pipe relining.

### SUMMARY

In aspects presented herein, an epoxy resin pipelining assembly provide an optimal application of epoxy resin to a pipe in a portable, lightweight, cost efficient, and material efficient manner.

In an aspect, an example portable pipelining assembly is described. The example assembly includes a pump system and a brush system. The pump system comprises a first motor coupled to a power supply, a pump coupled to the first motor, a reservoir coupled to the pump and configured to store a liquid, a hose having a feed end with a first opening and a delivery end with a second opening, wherein the delivery end is opposite the feed end, and an output valve with a first end coupled to the pump and a second end coupled to the feed end of the hose. The brush system is coupled to the hose delivery end and comprises a brush handle having a distal end and a handle base coupled to the distal end of the brush handle, wherein the handle base comprises (i) a second motor that rotates the handle base and (ii) a conduit comprising a first base opening in fluid communication with the hose delivery end, and a second base opening opposite the first base opening, wherein the first base opening is in fluid communication with the second base opening. The brush system also comprises a plurality of brushes coupled to the handle base proximate to the second base opening, wherein the plurality of brushes rotate when the second motor rotates the handle base.

In some aspects, when the first motor is activated by the power supply, an axel of the first motor and an axel of the pump spin to cause a series of gears within the pump to create a vacuum at an inlet of the pump, causing the liquid to flow from the reservoir to the pump, from the pump to the output valve, and from the output valve to the hose. The pump can be a hydraulic pump and the liquid can be a component of an epoxy resin. Aspects of the pump system can further comprise a control box configured to determine a speed by which the liquid flows to the brush system through control of the first motor. A user can provide an input on the control box to determine the speed. In aspects, the plurality of brushes can each comprise a plurality of bristles that extend at least partially in a radial direction outward from the second base opening, and the plurality of bristles can apply the liquid as a coating of uniform thickness when the second motor rotates the handle base and the pump is activated.

In another aspect, an example portable pipelining assembly is described. The example assembly includes a dual pump system comprising a first pump system and a second pump system and a brush system. The first pump system and the second pump system each comprise a primary motor coupled to a power supply, a pump coupled to the primary motor, a reservoir coupled to the pump, wherein the reservoir of the first pump system is configured to store a first liquid and the reservoir of the second pump system is configured to store a second liquid, a hose having a feed end with a first opening and a delivery end with a second opening, wherein the delivery end is opposite the feed end, and an output valve with a first end coupled to the pump and a second end coupled to the feed end of the hose. The brush system is coupled to the hose delivery end of the first pump system and the hose delivery end of the second pump system. The brush system comprises a brush handle having a distal end and a handle base coupled to the distal end of the brush handle, wherein the handle base comprises (i) a secondary motor that rotates the handle base, (ii) a first conduit comprising a first base opening in fluid communication with the hose delivery end of the first pump system, and a second base opening opposite the first base opening, wherein the first base opening is in fluid communication with the second base opening, and (iii) a second conduit comprising a third base opening in fluid communication with the hose delivery end of the second pump system, and a fourth base opening opposite the third base opening, wherein the third base opening is in fluid communication with the fourth base opening. The brush system also comprises a first brush, a second brush, and a third brush coupled to the handle base proximate to the second base opening and the fourth base opening, wherein the plurality of brushes rotate when the secondary motor rotates the handle base.

In some aspects, when each of the primary motors is activated by each power supply, an axel of each primary motor and an axel of each pump spins to cause a series of gears within each pump to create a vacuum at an inlet of each pump, causing the first liquid and the second liquid to flow from respective reservoirs to each pump, from each pump to each output valve, and from each output valve to each hose. Each pump can be a hydraulic pump, the first liquid can be an epoxy resin base, and the second liquid can be an epoxy catalyst. In aspects, the first liquid in the reservoir of the first pump system and the second liquid in the reservoir of the second pump system can flow to the brush system from the dual pump system such that the first brush, the second brush, and the third brush mix the first liquid with the second liquid and spread the first liquid and the second liquid onto the pipe as a coating of uniform thickness. The first brush, the second brush, and the third brush can each comprise a plurality of bristles that extend at least partially in a radial direction outward from the second base opening and the fourth base opening, and the plurality of bristles can apply the first liquid and the second liquid as a coating of uniform thickness when the secondary motor rotates the handle base and each pump is activated. In aspects of the first pump system and the second pump system, each can further comprise a control box configured to determine a speed by which the respective liquid flows to the brush system through control of each primary motor. Some aspects of the assembly can further comprise a base having a proximal surface and a distal surface, wherein the dual pump system is within the base and secured to the distal surface of the base, and a handle coupled to the proximal surface of the base.

In yet another aspect, an example method for using a portable pipelining assembly is described. The method begins by activating a primary motor in a pump system and receiving a liquid from a reservoir in the pump system. The method continues by pumping the liquid through an output valve and a hose. Then, the method receives the liquid from the hose at a brush system, wherein the brush system comprises a first brush, a second brush, and a third brush. The method continues by activating a secondary motor within the brush system to spin the first brush, the second brush, and the third brush. The method concludes by applying the liquid to a pipe, wherein the first brush, the second brush, and the third brush dispense the liquid as a coating of uniform thickness on an interior surface of the pipe.

In some aspects, the method can further operate by activating a second primary motor in the pump system, receiving a second liquid from a second reservoir in the pump system, pumping the second liquid through a second output valve and a second hose, receiving the second liquid from the second hose at the brush system, applying the second liquid to the pipe, wherein the first brush, the second brush, and the third brush mix the first liquid with the second liquid and dispense the first liquid and the second liquid as a coating of uniform thickness on the interior surface of the pipe. In some aspects, the liquid is an epoxy resin base and the second liquid is an epoxy catalyst. The method can also comprise manipulating a user control on a control box of the pump system to determine a speed of the primary motor. The pump system of the method can be within a base having a proximal surface and a distal surface, where the pump system is secured to the distal surface of the base, and a handle is coupled to the proximal surface of the base.

Further features and advantages, as well as the structure and operation of various aspects, are described in detail below with reference to the accompanying drawings. It is noted that the specific aspects described herein are not intended to be limiting. Such aspects are presented herein for illustrative purposes only. Additional aspects will be apparent to persons skilled in the relevant art(s) based on the teachings contained herein.

### BRIEF DESCRIPTION OF DRAWINGS

The accompanying drawings, which are incorporated herein and form a part of the specification, illustrate aspects of the present disclosure and, together with the description, further serve to explain the principles of the disclosure and to enable a person skilled in the pertinent art to make and use the disclosure.

FIG. 1 is an illustration of a dual epoxy pump system, according to some aspects of the present disclosure.

FIG. 2 is an illustration of an internal view of the dual epoxy pump system, according to some aspects of the present disclosure.

FIG. 3 is an illustration of a top view of the dual epoxy pump system, according to some aspects of the present disclosure.

FIG. 4 is an illustration of an internal view of the dual epoxy pump system, according to some aspects of the present disclosure.

FIG. 5 is an illustration of a brush system, according to some aspects of the present disclosure.

FIG. 6 is an illustration of a front view of the dual epoxy pump system, according to some aspects of the present disclosure.

FIG. 7A is an illustration of a left-side view of the dual epoxy pump system, according to some aspects of the present disclosure.

FIG. 7B is an illustration of a right-side view of the dual epoxy pump system, according to some aspects of the present disclosure.

FIG. 8 is an illustration of a rear view of the dual epoxy pump system, according to some aspects of the present disclosure.

FIG. 9 is a flowchart of a method for using a portable pipelining assembly, according to some aspects of the present disclosure.

In the drawings, like reference numbers generally indicate identical or similar elements. Additionally, generally, the left-most digit(s) of a reference number identifies the drawing in which the reference number first appears.

Aspects of the present disclosure will be described with reference to the accompanying drawings.

### DETAILED DESCRIPTION

Provided herein are apparatus, device, system, method, and/or computer-readable medium aspects, and/or combinations and sub-combinations thereof for a lightweight, portable epoxy pipelining assembly including a dual epoxy pump system and a brush system.

As described above, conventional systems and methods for relining pipes are both expensive, wasteful, and require the use of heavy, non-portable machinery. Aspects herein solve these technological problems using an innovative epoxy pipelining assembly, including the dual epoxy pump system and the brush system. The dual epoxy pump system is a lightweight, portable unit designed to mix and apply epoxy resin and catalyst with precision. It features two reservoirs mounted on a structural base, each connected to a motor-driven pump. These pumps draw fluids from the reservoirs and deliver them through hoses to the brush system. A control box allows users to adjust motor speeds, enabling accurate control of the relining speed and the resin-to-catalyst ratio, which is essential for proper curing. The brush system is the final application stage. It includes a motorized handle with three brushes that rotate to mix and evenly spread the epoxy inside pipes. Fluid is delivered directly to the brush base via the hoses, and the brushes ensure uniform coating by mixing and distributing the epoxy as they rotate. This system replaces heavier, air-compression-based setups and offers improved portability and control for pipe-lining applications.

Aspects herein provide various benefits. For example, the dual epoxy pump system in combination with the brush system eliminates need for an air compressor to mix and combine the epoxy resin base and epoxy catalyst. Instead, the system uses hydraulic pumps to apply the two epoxy components in a unform fashion to the interior of a pipe. The use of dual hydraulic pumps in part allows for the overall lightweight and portability of the assembly.

Additionally, the present system ensures mixing and an even application of the epoxy resin through its brush system, which is a feature that conventional methods cannot achieve without additional tools. The integrated brush system eliminates the need for spray heads and compressors by mechanically mixing and applying the epoxy directly inside the pipe. The rotating brushes ensure uniform coating and thickness, while the motorized handle allows for controlled, consistent applications—solving both spatial and thermal challenges in pipe relining.

Further, the dual epoxy pump system has the advantage of keeping the epoxy resin base and epoxy catalyst separate until the moment of application. The dual epoxy pump system addresses this by delivering unmixed epoxy resin and catalyst separately through dedicated reservoirs and pumps, allowing precise control over mixing ratios and timing. This prevents early curing inside hoses and minimizes waste, improving both cost-efficiency and material usage.

### Dual Pump System

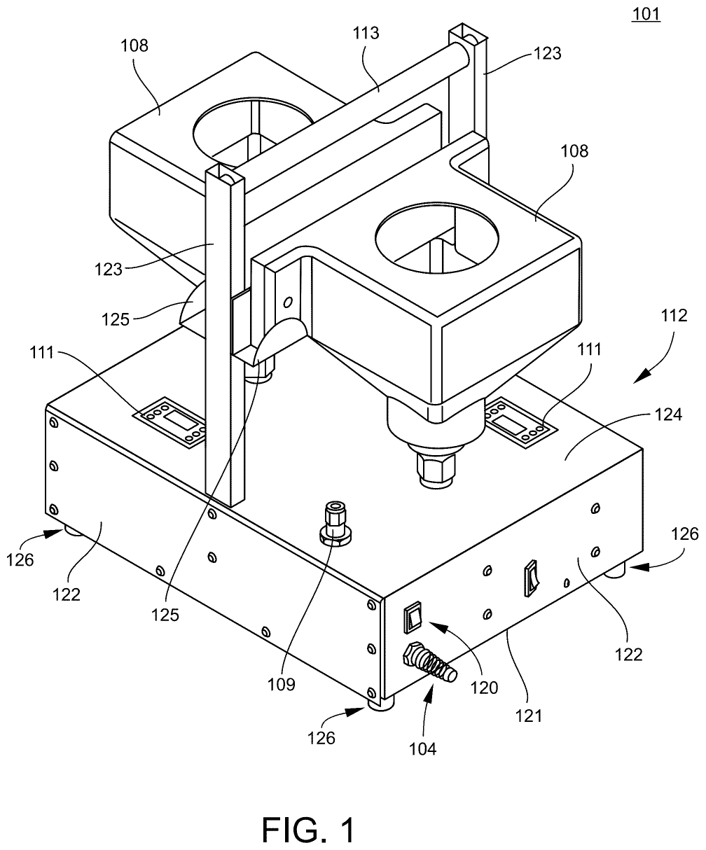

FIG. 1 is an illustration of a dual epoxy pump system 101, according to some aspects of the present disclosure. System 101 includes a structural base 112, one or more reservoirs 108, and a handle 113, among various other components.

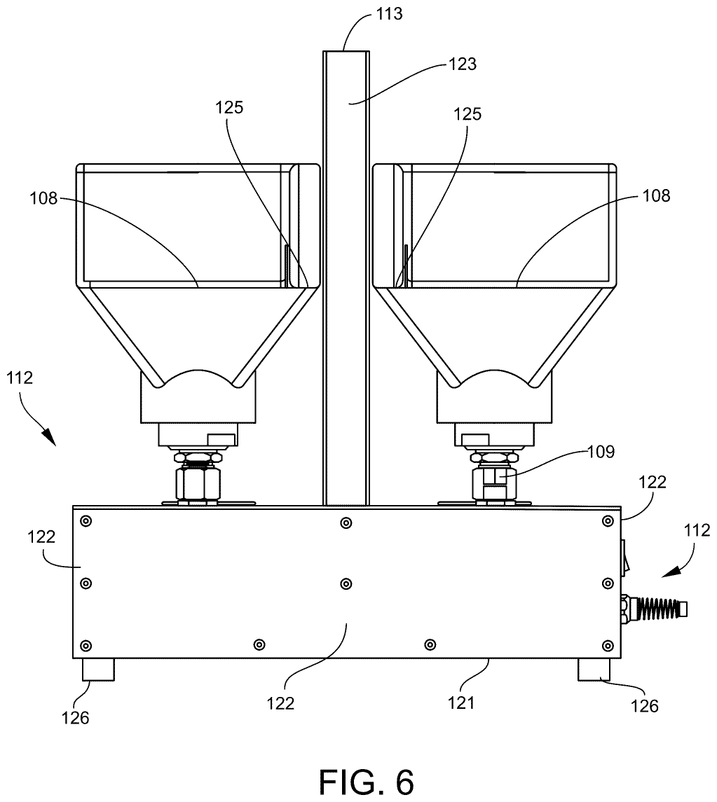

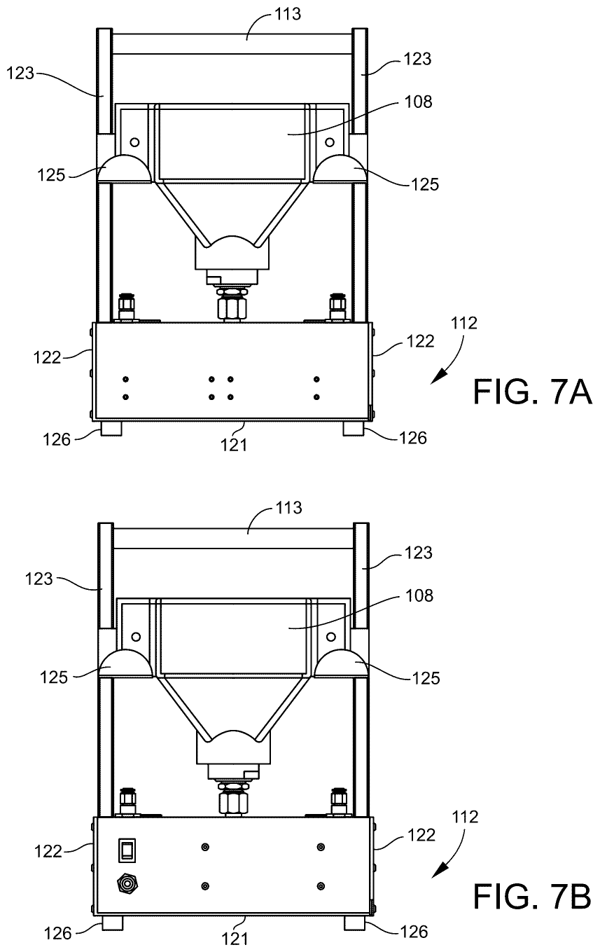

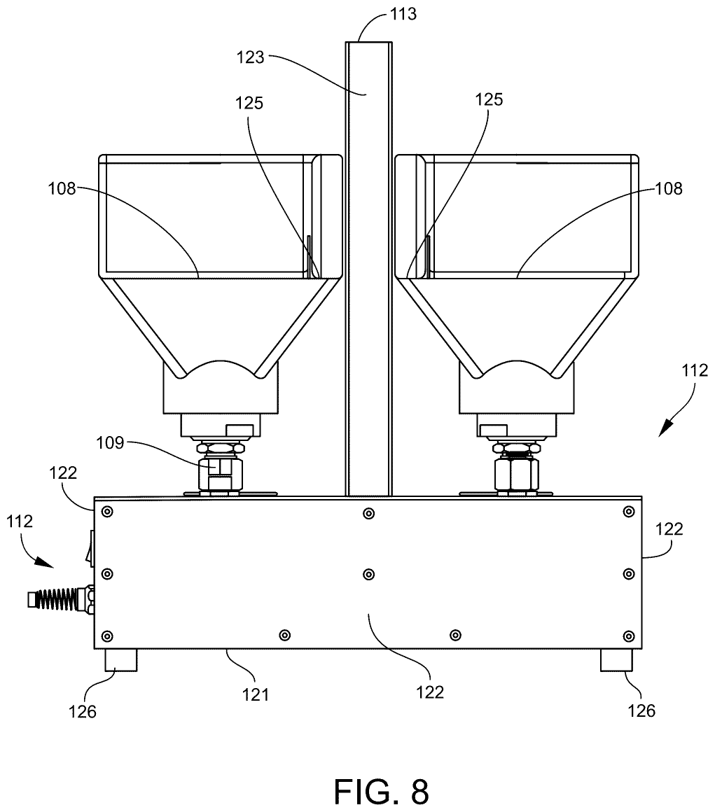

Base 112 provides structural support for system 101 and houses internal components, protecting them from bumps, scratches, water, and contaminants. Base 112 has a rectangular bottom 121 (e.g., a distal surface) and four side panels 122 coupled to the rectangular bottom 121. Base 112 is shaped as a rectangular prism, but can alternatively be shaped as any other geometric prism. The four panels 122 are defined by two longer panels 122, as shown in FIGS. 6 and 8, and two shorter panels 122, as shown in FIGS. 7A and 7B. Panels 122 and rectangular bottom 121 can be coupled to one another using one or more fasteners. The fasteners may include, but are not limited to, screws, bolts, rivets, pins, clips, clamps, or other suitable joining mechanisms. Fasteners may be positioned at strategic locations to maintain structural integrity, facilitate modularity, or enable access for maintenance of system 101 or replacement of internal components. Fasteners may be fabricated from a variety of materials, including metals such as stainless steel, aluminum, titanium, or brass; polymers such as nylon, polycarbonate, or acetal; or composite materials offering enhanced strength-to-weight ratios.

Surface treatments such as anodizing, plating, coating, or passivation may be applied to improve corrosion resistance, wear characteristics, or aesthetic appearance. Alternative configurations may include threaded, press-fit, snap-fit, or magnetic fasteners, as well as integrated fastening features formed directly into the housing or mating components. In some embodiments, tool-less fasteners may be used to simplify assembly and disassembly. The selection and arrangement of fasteners may vary based on factors such as load distribution, environmental exposure, vibration resistance, and manufacturing constraints. These fasteners may be configured for permanent or removable attachment. As such, one or more of panels 122 can be configured as removable panels. For example, as shown in FIG. 6 with respect to a front panel 122 and as shown in FIG. 8 with respect to a rear panel 122, a panel 122 can be removed, as needed, to repair and service system 101.

Panels 122 have one or more ports or cutouts for interface between internal components of system 101 and the external environment. For example, as shown in FIG. 1, a power cord port can exist in one of the panels 122, such that a power cord 104 is coupled to system 101. In another example, a cutout exists for an on/off switch 120 that allows a user to control whether electrical power is received at a power supply 105.

Base 112 has two arms 123 coupled to each of the longer sides of the rectangular bottom 121 and each arm 123 is coupled to the handle 113 at the top. Handle 113 provides portability to system 101, such that a user can easily transport system 101. Base 112 also has a cover 124 (e.g., a proximal surface) that is secured atop the side panels 122. Two arms 123 can be coupled to cover 124 or through cover 124, with handle 113 coupled to each arm 123. Cover 124 has one or more ports by which corresponding output valves 109 can interface between internal components of system 101 and one or more hoses 110. Cover 124 can also have one or more cutouts such that one or more control boxes 111, coupled to internal components of system 101, can be accessed by a user of system 101.

Base 112 has four feet 126 coupled to the bottom of rectangular bottom 121 in each corner. Feet 126 lift system 101 off the ground to prevent moisture or dirt from touching base 112 or getting inside and affecting internal components. Feet 126 also stabilize system 101 by absorbing movement of system 101 and channeling it into the ground. Feet 126 can be made of, for example, rubber material or hard plastic, or can take the form of cylindrical posts, blocks, brackets, or wheels. Suitable materials for base 112, bottom 121, panels 122, and cover 124 may include metals, such as aluminum, titanium stainless steel, or magnesium alloys for applications requiring high structural integrity and heat dissipation. Alternatively, polymers such as ABS, polycarbonate, polypropylene, or high-density polyethylene may be used for lightweight, corrosion-resistant, and cost-effective construction. In some aspects, composite materials such as fiberglass-reinforced plastics or carbon fiber laminates may be employed to achieve a balance of strength, weight, and durability. Base 112, bottom 121, panels 122, and cover 124 may also incorporate coatings, surface treatments, or liners to enhance performance under specific environmental conditions, such as exposure to moisture, chemicals, UV radiation, or temperature extremes. Additional design considerations may include impact resistance, vibration damping, and electromagnetic shielding, depending on the operating environment and regulatory requirements.

Base 112 effectively surrounds internal components of system 101 and leaves exposed two reservoirs 108. Base 112 has four shelves 125 coupled to the two arms 123. Reservoirs 108 sit on and are fastened to shelves 125. Shelves 125 hold up the reservoirs 108 and provide stability to reservoirs 108.

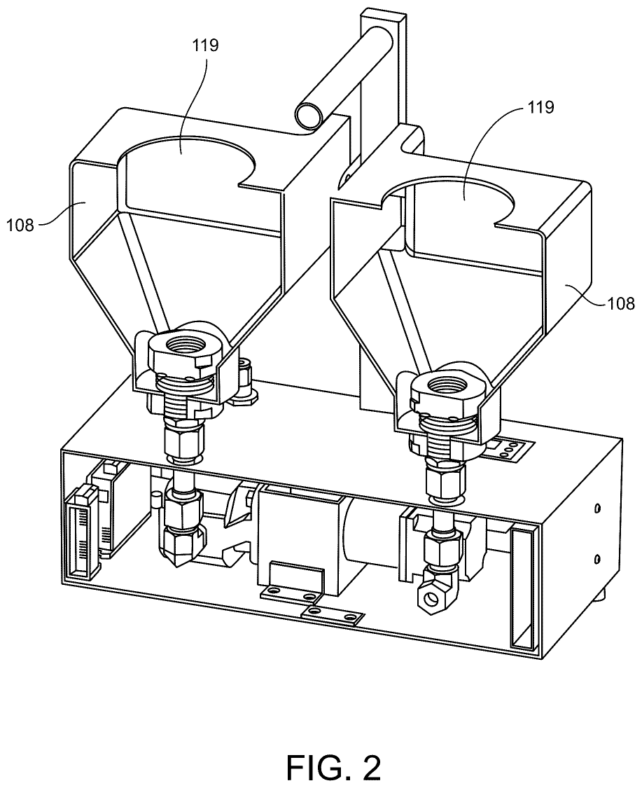

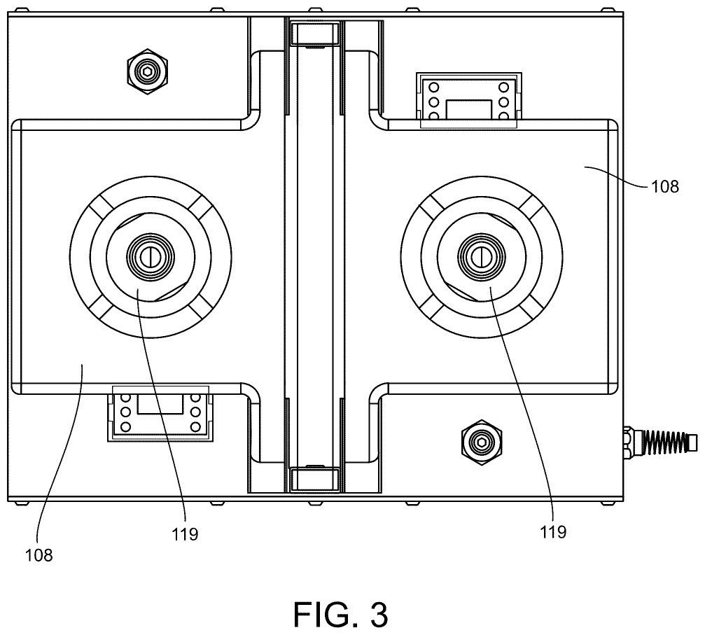

FIG. 2 is an illustration of an internal view of the reservoirs 108 of the dual epoxy pump system 101 and FIG. 3 is an illustration of a top view of the reservoirs 108 of the dual epoxy pump system 101, according to some aspects of the present disclosure. As shown, the liquid is poured through a reservoir's opening 119 located at the top of a reservoir 108 such that the liquid is contained within the reservoir 108. Liquid in a first reservoir 108 can be an epoxy resin base and liquid in a second reservoir 108 can be an epoxy catalyst, or vice versa.

Reservoirs 108 can be constructed from various materials, including high-performance polymers such as fluoropolymers (e.g., PTFE, FEP), polyethylene (e.g., HDPE, UHMWPE), polypropylene, or polyvinylidene fluoride (PVDF), which offer excellent resistance to epoxy resins and other reactive fluids. In some aspects, reservoirs 108 can be fabricated from stainless steel or anodized aluminum for enhanced mechanical strength and thermal conductivity, particularly in applications involving temperature-sensitive formulations. Composite materials or multilayer constructions may also be used to combine chemical resistance with structural rigidity. Additional design considerations may include anti-stick or non-reactive internal coatings to prevent buildup or cross-contamination between different fluid types.

Reservoirs 108 may include reinforcements or flexible sections to accommodate pressure changes or fluid expansion. In certain aspects, reservoirs 108 may be equipped with thermal insulation, grounding features for electrostatic discharge protection, or integrated sensors for monitoring fluid level, temperature, or viscosity. Reservoirs 108 can be opaque to protect the liquids from UV light, preserving their chemical nature. Reservoirs 108 also prevent contamination, including moisture contamination, cross-contamination of the epoxy resin base and epoxy catalyst, and exposure to other contaminates, such as dirt, sand, or dust particles. Those skilled in the art will appreciate that the pipelining assembly can house and apply a variety of liquids, such as topcoats and finishes, and those liquids can be applied to pipes of different materials, such as cast iron, concrete, PVC, fiberglass, clay, or ductile pipeline.

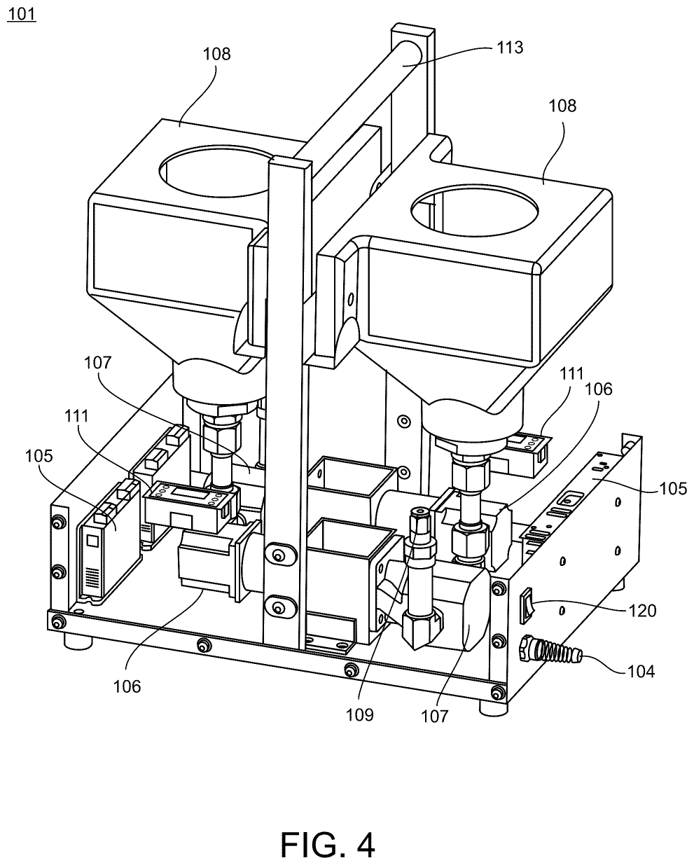

FIG. 4 is an illustration of an internal view of base 112 of dual epoxy pump system 101, according to some aspects of the present disclosure. Within or coupled to base 112 are a power cord 104, one or more power supplies 105, one or more electric motors 106, and one or more identical pumps 107, among various other components. These components can be coupled to any of the surfaces of base 112 (e.g., bottom 121, panels 122, and cover 124). In an example aspect, base 112 includes one power cord 104, two power supplies 105, two electric motors 106, and two identical pumps 107. In this way, base 112 can include dual epoxy pump system 101 as two independent pump systems.

Pumps 107 are configured to transfer liquid materials from reservoirs 108 to an external device or application point, such as output valves 109. Pump 107 may be used to handle a range of fluid types, including epoxy compounds, topcoats, finishes, and other chemically active or viscous substances. Pump 107 may be implemented in various forms, including hydraulic pumps, peristaltic pumps, piston pumps, vane pumps, diaphragm pumps, gear pumps, or centrifugal pumps, depending on the viscosity, flow rate, and pressure requirements of the fluid being transferred. Pump 107 may be constructed from materials selected for chemical compatibility, mechanical durability, and resistance to wear and corrosion. Suitable materials may include stainless steel, anodized aluminum, or chemically resistant polymers such as PTFE, PVDF, or polypropylene. In some aspects, internal components of pump 107, such as seals, diaphragms, or tubing, may be fabricated from elastomers like EPDM or silicone to ensure long-term performance with reactive or abrasive fluids. In certain aspects, pump 107 may be configured to operate in continuous or intermittent modes, and may include safety features such as backflow prevention, overload protection, or leak detection.

Pumps 107 are each driven by a motor 106. In various aspects, motors 106 are configured to provide mechanical power to pumps 107 for the purpose of transferring fluid materials such as epoxy compounds, topcoats, finishes, or other liquids. Motor 106 may be implemented in a variety of forms, including brushed or brushless DC motors, AC induction motors, stepper motors, or hydraulic motors, depending on the specific performance requirements such as torque, speed, duty cycle, and control precision. For example, in aspects where motors 106 are stepper motors, they can be configured to vary speed in small increments to precisely control the volume and speed of fluid flow.

Motor 106 may be constructed from materials selected to optimize thermal performance, mechanical durability, and resistance to environmental factors. Housing components may be fabricated from metals such as aluminum or stainless steel for strength and heat dissipation, or from engineered polymers for lightweight and corrosion-resistant applications. Internal components such as windings, bearings, and shafts may be made from copper alloys, hardened steel, or ceramic materials to enhance electrical efficiency and mechanical longevity. In some aspects, motor 106 may include integrated cooling features such as heat sinks, fans, or liquid cooling channels to manage thermal loads during extended operation. Motor 106 may also be equipped with sensors for monitoring speed, position, temperature, or current draw, and may interface with control systems, such as control boxes 111, for variable speed operation, feedback regulation, or fault detection.

Motors 106 are each connected to a power supply 105 through power cord 104. In various aspects, power supply 105 is configured to deliver electrical energy to one or more electrically driven components, such as motors 106, pumps 107, actuators, or control circuitry. Power supply 105 may be integrated within system 101 or provided as an external unit, and may be configured to receive input power from an AC mains source, a DC power source, or a renewable energy system such as solar or wind. Power supply 105 may include one or more of the following: transformers, rectifiers, voltage regulators, inverters, or battery management systems.

In some aspects, power supply 105 may incorporate energy storage elements such as rechargeable batteries, supercapacitors, or fuel cells to provide backup power or enable portable operation. Alternative configurations of power supply 105 may include wired or wireless power delivery, including inductive or resonant coupling systems. Power supply 105 may be adapted to provide variable voltage or current levels to accommodate different operational modes of motors 106 or pumps 107, such as startup, steady-state, or high-load conditions. In certain aspects, power supply 105 may be controlled by a microcontroller or programmable logic device to enable intelligent power management, fault detection, or energy efficiency optimization.

Motors 106 can be activated based on the configuration of on/off switch 120. In various aspects, switch 120 is configured to control the operational state of one or more components within system 101 by selectively enabling or disabling the flow of electrical power. Switch 120 may be used to activate or deactivate devices such as motors 106, pumps 107, control boxes 111, or other electrically powered subsystems. Switch 120 may be implemented in a variety of forms, including mechanical toggles, push-buttons, rocker switches, slide switches, rotary switches, or electronic switching elements such as transistors, relays, or solid-state devices. Switch 120 may be positioned for user accessibility on an external surface of a panel 122, or may be integrated within system 101 for internal or automated control.

In certain aspects, switch 120 may be manually operated, remotely actuated, or automatically triggered based on system conditions or programmed logic. Wireless control options may include Bluetooth, Wi-Fi, infrared, or other RF-based protocols. Materials used in switch 120 may include metals, polymers, elastomers, or composite materials selected for durability, electrical insulation, tactile feedback, and environmental resistance. Additional configurations may include momentary or latching functionality, multi-position switching, or integration with visual indicators such as LEDs to convey operational status. In some aspects, switch 120 may be part of a safety interlock system or include lockout/tagout features to prevent unintended activation.

Each motor 106 is coupled to a pump 107 by screwing an axel of motor 106 and an axel of pump 107 to a metal sheet situated between the two axels. Each pump 107 is coupled to a respective reservoir 108. When motors 106 operate (e.g., activated by power supply 105), the axel of each motor 106 and the axel of each pump 107 rotate or spin to cause a series of gears in each pump 107 to rotate. The rotating gears generate a vacuum at an inlet of each pump 107, which forces liquid from respective reservoirs 108 into pumps 107, from pumps 107 to respective output valves 109, and from respective output valves 109 to respective hoses 110.

Respective output valves 109 are coupled to brush system 102 via one or more hoses 110. In various aspects, hoses 110 are configured to transport liquid materials, such as epoxy compounds, topcoats, finishes, and other fluid substances, from output valves 109 to a dispensing implement, such as brush system 102. In this way, hoses 110 have a feed end with a first opening and a delivery end with a second opening. The delivery end is opposite the feed end of hoses 110. Respective output valves 109 can each have a first end coupled to each pump 107 and a second end coupled to the feed end of hoses 110. Hoses 110 may be constructed from materials selected to ensure chemical compatibility, flexibility, durability, and resistance to pressure and environmental exposure. The material properties of hoses 110 are critical to maintaining fluid integrity, preventing leaks, and ensuring consistent flow during operation.

Suitable materials for hoses 110 may include chemically resistant polymers such as PTFE, FEP, or PVDF, which offer excellent performance with reactive or solvent-based fluids. Other options may include flexible thermoplastics like polyurethane, nylon, or polyethylene, which provide a balance of flexibility, abrasion resistance, and cost-effectiveness. In some aspects, hoses 110 may incorporate multilayer constructions, combining an inner chemically resistant liner with outer layers designed for mechanical protection or reinforcement.

Hoses 110 may also be transparent for visual inspection of fluid flow, have anti-kink properties to maintain consistent delivery, or have reinforcement with braided fibers or wire to withstand elevated pressures. Hose 110 may also be equipped with fittings or couplings made from stainless steel, brass, or chemically resistant plastics to ensure secure and leak-free couplings with various components, such as output valves 109 and brush system 102. Each pump 107 pumps the liquids through hoses 110 to brush system 102.

Each pump 107 can be coupled to a control box 111. The control box 111 is configured to increase or decrease speed of motors 106 to control the flow speed of liquid from pump 107 to brush system 102. Control box 111 can have one or more user speed controls that accept input from a user. Control box 111 allows for a user to determine a proportion of epoxy resin base to epoxy catalyst by varying the speed in which the two components are pumped from system 101 and then applied onto pipes by brush system 102. For the epoxy resin to fully cure and develop its physical properties, an accurate ratio is important. Controlling the ratio may also be required when ambient temperature conditions change to a degree that affects the curing speed of the epoxy components. Additionally, by controlling the ratio, the user can account for varying unique epoxy resin base and epoxy catalyst formulations based on the kind of base and catalyst used. For example, it is common in epoxy resin applications to have a 2:1 mix ratio of epoxy resin base to epoxy catalyst; however, the ratio may be varied based on the type of application or chemicals used. In one embodiment, the assembly is configured to apply a 1:1 ratio of epoxy resin base to catalyst.

In an embodiment, power supply 105 is a 30 amp supply, and each pump 107 has a flow rate of about 4 parts per million (ppm). As would be understood by a person of ordinary skill in the art, power supply 105 and pumps 107 can be configured in other configurations. Entire system 101 can weigh approximately sixty pounds, which is much lower than conventional systems using air compressions that can weigh over one hundred fifty pounds. In other aspects, system 101 can be configured to weigh less than or more than sixty pounds.

### Brush System

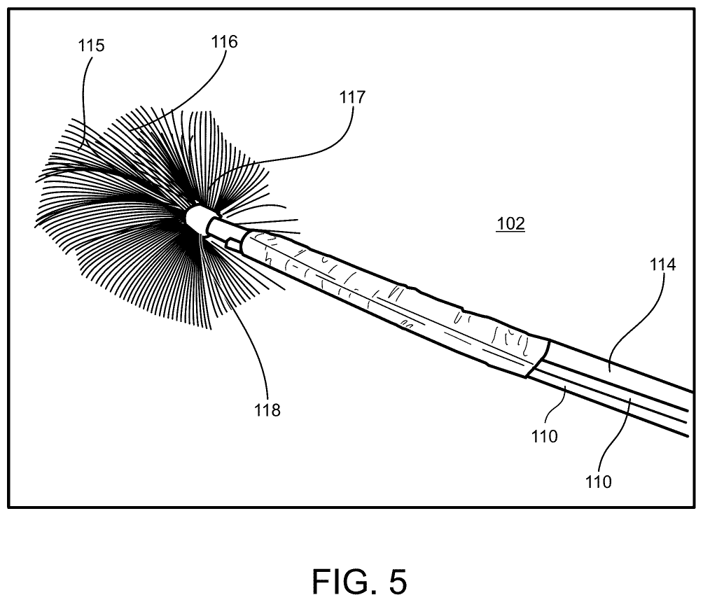

FIG. 5 is an illustration of a brush system 102, according to some aspects of the present disclosure. Brush system 102 has a brush handle 114 with a first brush 115, a second brush 116, and a third brush 117 attached to a handle base 118. In other aspects, brush system 102 can be configured with more or less than three brushes. Brush handle 114 can have a distal end and handle base 118 can be coupled to the distal end of brush handle 114. Handle base 118 can have a conduit corresponding to each pump system 101. Each conduit includes a first base opening in fluid communication with the delivery end of hose 110 and a second base opening opposite the first base opening. In this way, the first base opening is in fluid communication with the second base opening. In aspects involving multiple pump systems, multiple similar conduits exist in brush system 102.

The various brushes are configured to apply fluid materials, such as epoxy compounds, topcoats, and finishes, to the surface of a pipe or similar substrate as a coating of uniform thickness. A plurality of bristles of each of the various brushes may be fabricated from synthetic materials such as nylon, polyester, or polypropylene, which offer resistance to chemical degradation and maintain stiffness or flexibility depending on the desired application technique.

For more aggressive or precision applications, bristles may be made from natural fibers such as hog hair or horsehair, or from chemically treated blends to enhance solvent resistance. In some aspects, metal wire bristles may be used for surface preparation or for applying highly viscous compounds. The brush body and handle may be constructed from materials such as polypropylene, ABS, wood, or stainless steel, selected for ergonomic handling, solvent resistance, and structural integrity.

Bonding methods to affix the plurality of bristles to handle base 118 may include mechanical crimping, epoxy adhesives, or thermal fusion, depending on the expected exposure to chemicals and mechanical stress. The plurality of bristles of each of the plurality of brushes can be configured to extend at least partially in a radial direction from an opening of a conduit in handle base 118. Two hoses 110 of system 101 (e.g., the delivery end of hoses 110) are attached to brush system 102 with ends of each hose positioned proximate to the handle base 118 closest to third brush 117. In various aspects, an attachment mechanism may be provided to enable secure and functional connection of hoses 110 to handle base 118, which supports the various brushes used for fluid application. The attachment mechanism may be configured to facilitate fluid delivery from hoses 110 to the brushes while maintaining a sealed and stable interface. This mechanism may include threaded fittings, quick-connect couplings, barbed inserts, or compression seals, depending on the fluid type, pressure requirements, and ease-of-use considerations.

Materials used in the attachment mechanism may include stainless steel, brass, or chemically resistant polymers such as nylon, polypropylene, or PVDF, selected for durability, corrosion resistance, and compatibility with epoxy compounds, topcoats, and finishes. In some aspects, the attachment may incorporate flexible gaskets or O-rings made from elastomers such as EPDM or silicone to ensure leak-free operation under varying temperature and pressure conditions. The attachment mechanism may be integrated into or mounted onto handle base 118, and may include features such as swivel joints for improved maneuverability, locking tabs for secure engagement, or modular ports to accommodate multiple hoses. In certain aspects, the design may allow for quick disconnection and cleaning, or may include flow control valves to regulate fluid delivery to the various brushes.

Inside handle base 118 is a motor attached to a power source that, when activated, spins first brush 115, second brush 116, and third brush 117. In various aspects, the motor is configured to rotationally drive handle base 118 to which the various brushes are attached for the purpose of applying fluid materials with a uniform coating thickness across the interior surface of a pipe.

The motor may be implemented as a compact DC motor, stepper motor, or brushless motor. Housing components of the motor may include aluminum, stainless steel, or high-performance polymers, while internal elements such as windings and shafts may be made from copper, hardened steel, or ceramic composites. In some aspects, the motor may include integrated bearings or bushings to support smooth rotation of the brush head under varying loads. Additional features of the motor may include variable speed control, reversible rotation, and feedback mechanisms such as encoders or Hall-effect sensors for precise brush positioning. The motor may be sealed or encapsulated to prevent ingress of epoxy or other fluids, and may be mounted using vibration-damping materials to reduce noise and mechanical stress. In certain aspects, the motor may be part of an automated or semi-automated system for consistent and uniform fluid application across curved or irregular surfaces. Handle base 118 can spin clockwise or counterclockwise.

The epoxy resin base and catalyst are pumped out of hoses 110 and into a pipe interior. The leading first brush 115 mixes the epoxy components, and the trailing second 116 and third 117 brushes further mix the two components and evenly spread the mixture to facilitate a uniform thickness. In this manner, brush system 102 applies the epoxy resin onto the inside of pipes and ensures the pipes are evenly coated with the epoxy resin.

### Operating the Assembly

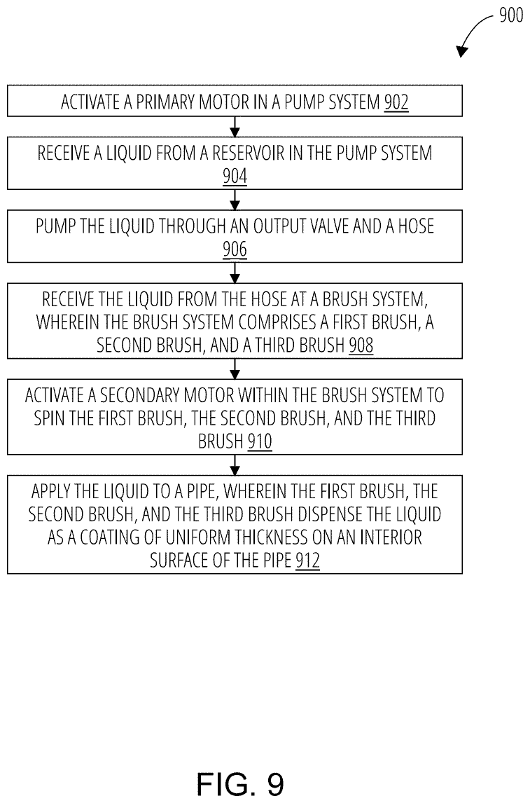

FIG. 9 is a flowchart for a method 900 for using a portable pipelining assembly, according to an aspect of the invention. It is to be appreciated that more or fewer steps can be needed to perform the disclosure provided herein. Further, some of the steps can be performed simultaneously, or in a different order than shown in FIG. 9, as will be understood by a person of ordinary skill in the art. Method 900 can be implemented using dual epoxy pump system 101 and brush system 102. However, method 900 is not limited to that example aspect.

In operation 902, method 900 activates a primary motor in a pump system. The primary motor can be understood as motor 106, within pump system 101. The primary motor can be activated when connected to a power supply, such as power supply 105. In operation 904, method 900 receives a liquid from a reservoir in the pump system. The reservoir can be understood as one of reservoirs 108. In operation 906, method 900 pumps the liquid through an output valve and a hose. The pump can be understood as a motor-driven hydraulic pump. This operation can be understood as pump 107 pumping the liquid through an output valve 109 and a hose 110.

In operation 908, method 900 receives the liquid from the hose at a brush system, wherein the brush system comprises a first brush, a second brush, and a third brush. The brushes can each include a plurality of bristles, as can be understood with first brush 115, second brush 116, and third brush 117. In operation 910, method 900 activates a secondary motor within the brush system to spin the first brush, the second brush, and the third brush. The secondary motor can be positioned within a handle base of the brush system, such as with handle base 118, and the brushes can be coupled to the handle base. In operation 912, method 900 applies the liquid to a pipe, wherein the first brush, the second brush, and the third brush dispense the liquid as a coating of uniform thickness on an interior surface of the pipe.

In aspects of method 900, method 900 can also include activating a second primary motor in the pump system, receiving a second liquid from a second reservoir in the pump system, pumping the second liquid through a second output valve and a second hose, receiving the second liquid from the second hose at the brush system, and applying the second liquid to the pipe. In these aspects, the first brush, the second brush, and the third brush mix the first liquid with the second liquid and dispense the first liquid and the second liquid as a coating of uniform thickness on the interior surface of the pipe. The liquid can be an epoxy resin base and the second liquid can be an epoxy catalyst. In these aspects, the epoxy resin base and epoxy catalyst can be effectively pumped out of hoses and into a pipe interior. The first brush can mix the epoxy components while the other brushes facilitate application of the components as a coating of uniform thickness on the pipe interior.

Aspects of method 900 can include various other operations and component interactions. For example, method 900 can include manipulating a user control on a control box of the pump system to determine a speed of the primary motor. The control box, such as control box 111, can be configured to increase or decrease speed of the primary motor to control the flow speed of liquid from the pump to the brush system. The pump system can also be within a base having a proximal surface and a distal surface, the pump system can be secured to the distal surface of the base, and a handle can be coupled to the proximal surface of the base. The base can be understood as base 112, configured to provide structural support to the pump system. The handle can be utilized by a user to transport the pump system. The handle can be understood as handle 113.

The foregoing discussion discloses and describes merely exemplary embodiments of the present disclosure. The example embodiments are provided so that this disclosure will be both thorough and complete and will fully convey the scope of the invention and enable one of ordinary skill in the art to make, use, and practice the invention. One skilled in the art will readily recognize from such discussion and from the accompanying drawings and claims that various changes, modifications and variations can be made therein without departing from the spirit and scope of the disclosure as defined in the following claims.

References herein to “one aspect,” “an aspect,” “an example aspect,” or similar phrases, indicate that the aspect described can include a particular feature, structure, or characteristic, but every aspect can not necessarily include the particular feature, structure, or characteristic. Moreover, such phrases are not necessarily referring to the same aspect. Further, when a particular feature, structure, or characteristic is described in connection with an aspect, it would be within the knowledge of persons skilled in the relevant art(s) to incorporate such feature, structure, or characteristic into other aspects whether or not explicitly mentioned or described herein. Additionally, some aspects can be described using the expression “coupled” and “connected” along with their derivatives. These terms are not necessarily intended as synonyms for each other. For example, some aspects can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

Relative terms such as lower or bottom; upper or top; upward, outward, or downward; forward or backward; and vertical or horizontal may be used herein to describe one element's relationship to another element illustrated in the figures. It will be understood that relative terms are intended to encompass different orientations in addition to the orientation depicted in the drawings. By way of example, if a component in the drawings is turned over, elements described as being on the “bottom” of the other elements would then be oriented on “top” of the other elements. Relative terminology, such as “substantially” or “about,” describe the specified materials, steps, parameters, or ranges as well as those that do not materially affect the basic and novel characteristics of the claimed inventions as whole (as would be appreciated by one of ordinary skill in the art).

What is claimed is:

1. A portable pipelining assembly, the assembly comprising:
a pump system, the pump system comprising:
a first motor coupled to a power supply;
a pump coupled to the first motor;
a reservoir coupled to the pump and configured to store a liquid;
a hose having a feed end with a first opening and a delivery end with a second opening, wherein the delivery end is opposite the feed end; and
an output valve with a first end coupled to the pump and a second end coupled to the feed end of the hose; and
a brush system coupled to the hose delivery end, the brush system comprising:
a brush handle having a distal end;
a handle base coupled to the distal end of the brush handle, wherein the handle base comprises (i) a second motor that rotates the handle base and (ii) a conduit comprising a first base opening in fluid communication with the hose delivery end, and a second base opening opposite the first base opening, wherein the first base opening is in fluid communication with the second base opening; and
a plurality of brushes coupled to the handle base proximate to the second base opening, wherein the plurality of brushes rotate when the second motor rotates the handle base.

2. The assembly of claim 1, wherein when the first motor is activated by the power supply, an axel of the first motor and an axel of the pump spin to cause a series of gears within the pump to create a vacuum at an inlet of the pump, causing the liquid to flow from the reservoir to the pump, from the pump to the output valve, and from the output valve to the hose.

3. The assembly of claim 1, wherein (i) the plurality of brushes each comprise a plurality of bristles that extend at least partially in a radial direction outward from the second base opening, and (ii) the plurality of bristles apply the liquid as a coating of uniform thickness when the second motor rotates the handle base and the pump is activated.

4. The assembly of claim 1, wherein the pump is a hydraulic pump.

5. The assembly of claim 1, wherein the liquid is a component of an epoxy resin.

6. The assembly of claim 1, wherein the pump system further comprises a control box configured to determine a speed by which the liquid flows to the brush system through control of the first motor.

7. The assembly of claim 6, wherein the speed is determined by a user input on the control box.

8. A portable pipelining assembly, the assembly comprising:
a dual pump system comprising a first pump system and a second pump system, wherein the first pump system and the second pump system each comprise:
a primary motor coupled to a power supply;
a pump coupled to the primary motor;
a reservoir coupled to the pump, wherein the reservoir of the first pump system is configured to store a first liquid and the reservoir of the second pump system is configured to store a second liquid;
a hose having a feed end with a first opening and a delivery end with a second opening, wherein the delivery end is opposite the feed end; and
an output valve with a first end coupled to the pump and a second end coupled to the feed end of the hose; and
a brush system coupled to the hose delivery end of the first pump system and the hose delivery end of the second pump system, the brush system comprising:
a brush handle having a distal end;
a handle base coupled to the distal end of the brush handle, wherein the handle base comprises (i) a secondary motor that rotates the handle base, (ii) a first conduit comprising a first base opening in fluid communication with the hose delivery end of the first pump system, and a second base opening opposite the first base opening, wherein the first base opening is in fluid communication with the second base opening, and (iii) a second conduit comprising a third base opening in fluid communication with the hose delivery end of the second pump system, and a fourth base opening opposite the third base opening, wherein the third base opening is in fluid communication with the fourth base opening; and
a first brush, a second brush, and a third brush coupled to the handle base proximate to the second base opening and the fourth base opening, wherein the plurality of brushes rotate when the secondary motor rotates the handle base.

9. The assembly of claim 8, wherein when each of the primary motors is activated by each power supply, an axel of each primary motor and an axel of each pump spins to cause a series of gears within each pump to create a vacuum at an inlet of each pump, causing the first liquid and the second liquid to flow from respective reservoirs to each pump, from each pump to each output valve, and from each output valve to each hose.

10. The assembly of claim 8, wherein (i) the first brush, the second brush, and the third brush each comprise a plurality of bristles that extend at least partially in a radial direction outward from the second base opening and the fourth base opening, and (ii) the plurality of bristles apply the first liquid and the second liquid as a coating of uniform thickness when the secondary motor rotates the handle base and each pump is activated.

11. The assembly of claim 8, wherein each pump is a hydraulic pump.

12. The assembly of claim 8, wherein the first liquid is an epoxy resin base and the second liquid is an epoxy catalyst.

13. The assembly of claim 8, wherein the first liquid in the reservoir of the first pump system and the second liquid in the reservoir of the second pump system flow to the brush system from the dual pump system such that the first brush, the second brush, and the third brush mix the first liquid with the second liquid and spread the first liquid and the second liquid onto the pipe as a coating of uniform thickness.

14. The assembly of claim 8, wherein the first pump system and the second pump system each further comprises a control box configured to determine a speed by which the respective liquid flows to the brush system through control of each primary motor.

15. The assembly of claim 8, the assembly further comprising:
a base having a proximal surface and a distal surface, wherein the dual pump system is within the base and secured to the distal surface of the base; and
a handle coupled to the proximal surface of the base.

16. A method of using a portable pipelining assembly, the method comprising:
activating a primary motor in a pump system;
receiving a liquid from a reservoir in the pump system;
pumping the liquid through an output valve and a hose;
receiving the liquid from the hose at a brush system, wherein the brush system comprises a first brush, a second brush, and a third brush;
activating a secondary motor within the brush system to spin the first brush, the second brush, and the third brush; and
applying the liquid to a pipe, wherein the first brush, the second brush, and the third brush dispense the liquid as a coating of uniform thickness on an interior surface of the pipe.

17. The method of claim 16, the method further comprising:
activating a second primary motor in the pump system;
receiving a second liquid from a second reservoir in the pump system;
pumping the second liquid through a second output valve and a second hose;
receiving the second liquid from the second hose at the brush system; and
applying the second liquid to the pipe, wherein the first brush, the second brush, and the third brush mix the first liquid with the second liquid and dispense the first liquid and the second liquid as a coating of uniform thickness on the interior surface of the pipe.

18. The method of claim 17, wherein the liquid is an epoxy resin base and the second liquid is an epoxy catalyst.

19. The method of claim 16, the method further comprising:
manipulating a user control on a control box of the pump system to determine a speed of the primary motor.

20. The method of claim 16, wherein the pump system is within a base having a proximal surface and a distal surface, the pump system is secured to the distal surface of the base, and a handle is coupled to the proximal surface of the base.
